(19) United States
(12) Patent Application Publication
(10) Pub. No.: US 2014/0202287 A1
(43) Pub. Date: Jul. 24, 2014

(54) PNEUMATIC RATCHET WRENCH CAPABLE OF PREVENTING MIS-SWITCHING OF ROTATIONAL DIRECTION

(71) Applicant: Basso Industry Corp., Taichung (TW)

(72) Inventors: Chun-Chi Lai, Taichung (TW); Chien-An Liu, Taichung (TW)

(73) Assignee: Basso Industry Corp., Taichung (TW)

(21) Appl. No.: 14/157,767

(22) Filed: Jan. 17, 2014

(30) Foreign Application Priority Data
Jan. 21, 2013 (TW) 102102211

(51) Int. Cl. B25B 21/00

(52) U.S. Cl. CPC B25B 21/004
USPC 81/57.39

(57) ABSTRACT

A pneumatic ratchet wrench includes a driving head, a feeding path, a primary path, a secondary path, a valve member, and a trigger. Upon flow of air into the primary path, the driving head is rotated. Upon flow of air into the secondary path, the rotational direction of the driving head can be switched. When the trigger is not actuated, the valve member is at a first position so as to prevent air to flow from the feeding path to the primary path, while allowing air to flow from the feeding path to the secondary path. When the trigger is actuated, the valve member is moved to a second position so as to allow air to flow from the feeding path to the primary path, while preventing air to flow from the feeding path to the secondary path.

### CROSS-REFERENCE TO RELATED APPLICATION

This application claims priority of Taiwanese Application No. 102102211, filed on Jan. 21, 2013.

### BACKGROUND OF THE INVENTION

1. Field of the Invention

This invention relates to a pneumatic tool, and more particularly to a pneumatic ratchet wrench capable of preventing mis-switching of the rotational direction of a driving head.

2. Description of the Related Art

Referring to FIGS. 1 and 2, a pneumatic ratchet wrench 1 disclosed in U.S. Pat. No. 6,640,669 includes a body 11, a driving head 12 extending rotatably into the body 11, two movable racks 14 located respectively at two sides of the ratchet unit 13, two pushing blocks 15 disposed movably on the body 11 and operable to push and move one of the racks 14, an air motor 16, and a valve unit 17. The body 11 has a feeding path 111 in fluid communication with a compressed air source (not shown). The ratchet unit 13 includes a yoke 131 meshing with the driving head 12, a pawl 132 meshing with the drive head 12 and is variable in position to switch the rotational direction of the driving head 12, and a reverse gear 133 co-rotatable with the pawl 132 and engageable with one of the racks 14. The air motor 16 includes an air cylinder 161 in fluid communication with the feeding path 111, and an idle pin 162 driven by the air cylinder 171 to swing the yoke 131. The valve unit 17 includes a valve pin 171 closing openably the feeding path 111 and the air cylinder 161, and a trigger 172 disposed pivotally on the body 11 for controlling the valve pin 171.

As such, by pushing one of the pushing blocks 15, the corresponding rack 14 is activated to drive rotation of the reverse gear 133 and the pawl 132 to thereby change the position of the pawl 132 relative to the driving head 12, so that the driving head 12 can be rotated in the corresponding direction, thereby completing a rotational-direction changing operation. When it is desired to rotate the driving head 12, the trigger 172 is actuated so that the valve pin 171 is activated to open the feeding path 111 and the air cylinder 161. Hence, air flows from the feeding path 111 into the air cylinder 161 to drive the air cylinder 161, the idle pin 162, and the yoke 131 to thereby rotate the driving head 12.

However, when the air cylinder 161 drives rotation of the driving head 12 through the idle pin 162, either of the pushing blocks 15 may be pushed to activate the corresponding rack 14, the reverse gear 133, and the pawl 132. If this occurs, a flat surface of the driving head 12 will impact the pawl 132, thereby damaging the driving head 12 or the pawl 132. Consequently, smooth operation of the pneumatic ratchet wrench 1 is affected adversely, and the service life of the pneumatic ratchet wrench is reduced.

To overcome these drawbacks, in a copending U.S. patent application Ser. No. 13/939,712, the applicant proposes a design of changing the flowing direction of air by moving an open-close valve. Through this design, while the driving head 12 is being rotated, its rotational direction cannot be switched, and while the rotational direction of the driving head 12 is being switched, the driving head 12 cannot be rotated. However, the open-close valve is configured such that the total length of the pneumatic ratchet wrench is increased.

### SUMMARY OF THE INVENTION

The object of this invention is to provide a pneumatic ratchet wrench capable of preventing anti-switching of rotational direction, which can be operated smoothly and which has an increased service life.

According to this invention, a pneumatic ratchet wrench includes a driving head, a feeding path, a primary path, a secondary path, a valve member, and a trigger. Upon flow of air into the primary path, the driving head is rotated. Upon flow of air into the secondary path, the rotational direction of the driving head can be switched. When the trigger is not actuated, the valve member is at a first position so as to prevent air to flow from the feeding path to the primary path, while allowing air to flow from the feeding path to the secondary path. When the trigger is actuated, the valve member is moved to a second position so as to allow air to flow from the feeding path to the primary path, while preventing air to flow from the feeding path to the secondary path.

As such, no manual operation is required to control the flowing direction of air. Furthermore, a rotation driving operation and a rotational-direction switching operation with respect to a driving head are prevented from being performed simultaneously, thereby resulting in a smooth operation, an increase in the service life, and a reduction in the total volume and the total length.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a top view of a conventional pneumatic ratchet wrench disclosed in U.S. Pat. No. 6,640,669;

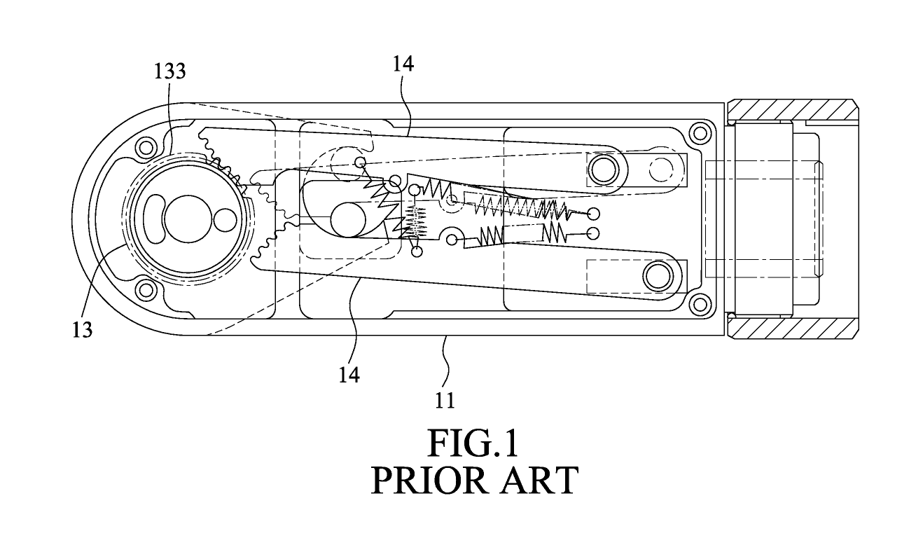

FIG. 2 is a sectional view of the conventional pneumatic ratchet wrench;

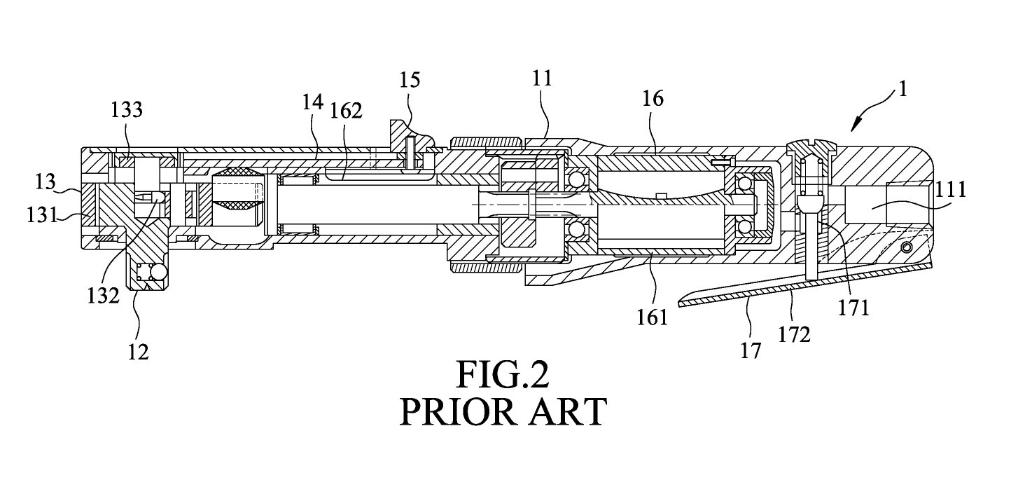

FIG. 3 is a sectional view of the preferred embodiment of a pneumatic ratchet wrench according to this invention;

FIG. 4 is a fragmentary sectional view of the preferred embodiment, illustrating that a valve member is disposed at a first position so as to open fluid communication between a feeding path and a secondary path;

FIG. 5 is a fragmentary sectional view of the preferred embodiment, illustrating that fluid communication between the feeding path and a primary path is closed by a switch valve;

FIG. 6 is a fragmentary sectional view of the preferred embodiment, illustrating that the valve member is disposed at a second position so as to close fluid communication between the feeding path and the secondary path; and

FIG. 7 is a fragmentary sectional view of the preferred embodiment, illustrating that the switch valve is operated to open fluid communication between the feeding path and the primary path.

### DETAILED DESCRIPTION OF THE PREFERRED EMBODIMENT

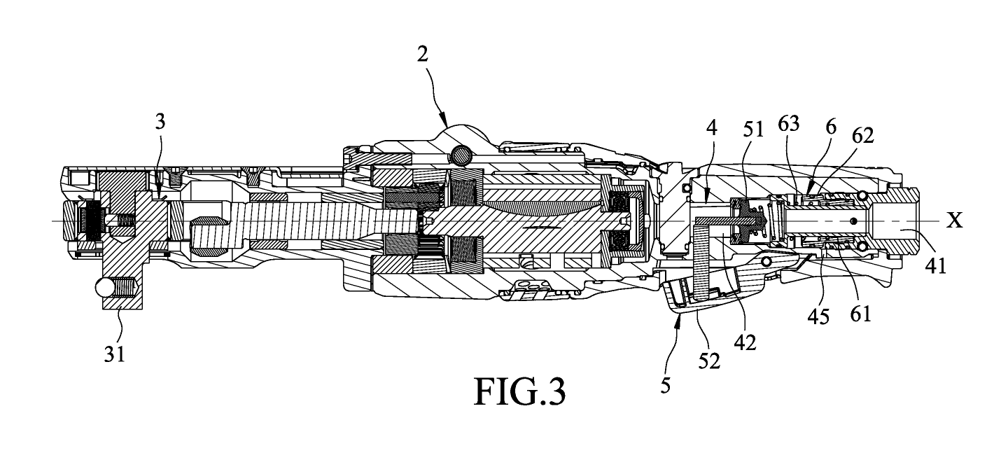

With reference to FIGS. 3, 4, and 5, the preferred embodiment of a pneumatic ratchet wrench according to this invention includes a body 2, an output unit 3, a flow path unit 4, a driving unit 5, and a valve unit 6.

The output unit 3 includes a driving head 31 extending into a front end portion of the body 2 and rotatable about a Z-axis. It should be noted that, a process for driving rotation of the driving head 31, a direction switching operation, and the detailed structures have been disclosed by the applicant in copending U.S. patent application Ser. No. 13/939,712, which is herein incorporated by reference in its entirety.

The flow path unit 4 is formed in the body 2, and includes a feeding path 41 extending along an X-axis direction perpendicular to the Z-axis, and permits flow of air thereinto, a primary path 42 in fluid communication with the feeding path 41 so as to guide flow of air to drive rotation of the driving head 31, a secondary path 43 in fluid communication with the feeding path 41 so as to guide flow of air to switch the rotational direction of the driving head 31, a connecting path 44 in fluid communication with the primary path 42, and a discharging hole 45 in fluid communication with the surroundings. The feeding path 41 is connected fluidly to the primary path 42 along the X-axis direction. The secondary path 43 and the connecting path 44 extend along the X-axis direction, and flank an assembly of the feeding path 41 and the primary path 42.

The driving unit 5 includes a switch valve 51 and a trigger 52. The switch valve 51 is positioned so as to close fluid communication between the feeding path 41 and the primary path 42, while allowing for flow of air from the feeding path 41 into the secondary path 43. The trigger 52 is disposed pivotally on the body 2, and is operable to activate the switch valve 51 so as to pen fluid communication between the feeding path 41 and the primary path 42. Hence, air flows from the feeding path 41 into the primary path 42 and the connecting path 44.

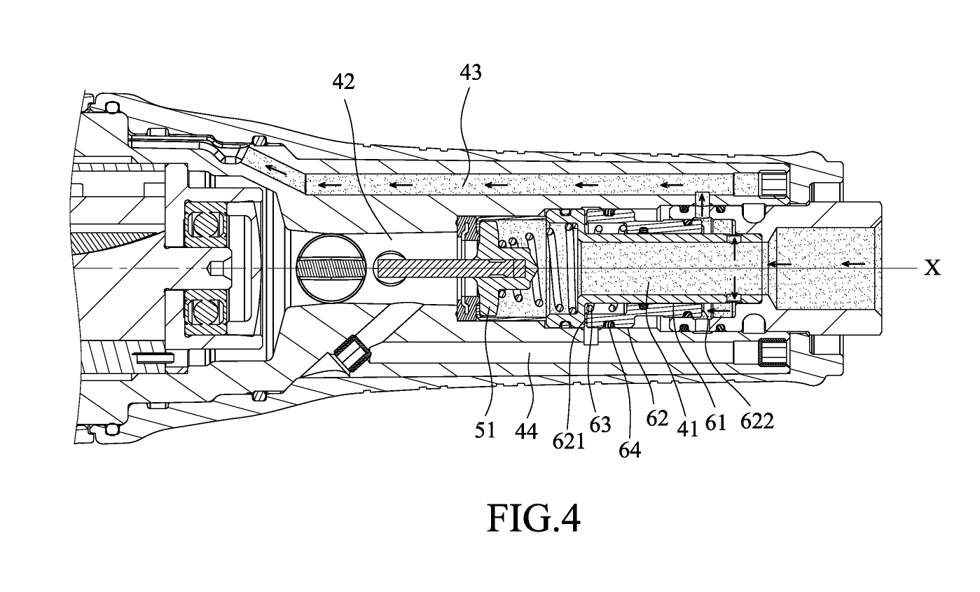

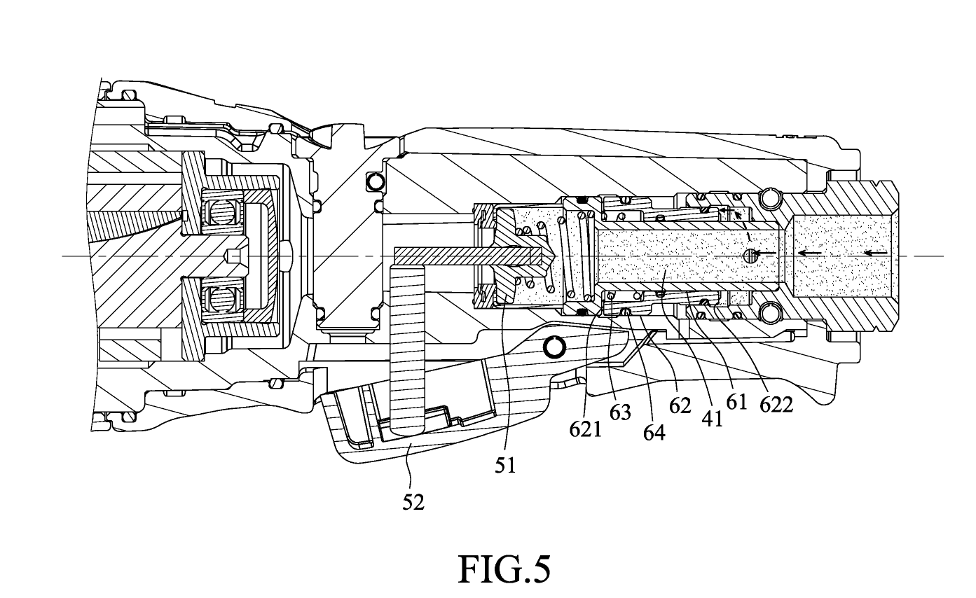

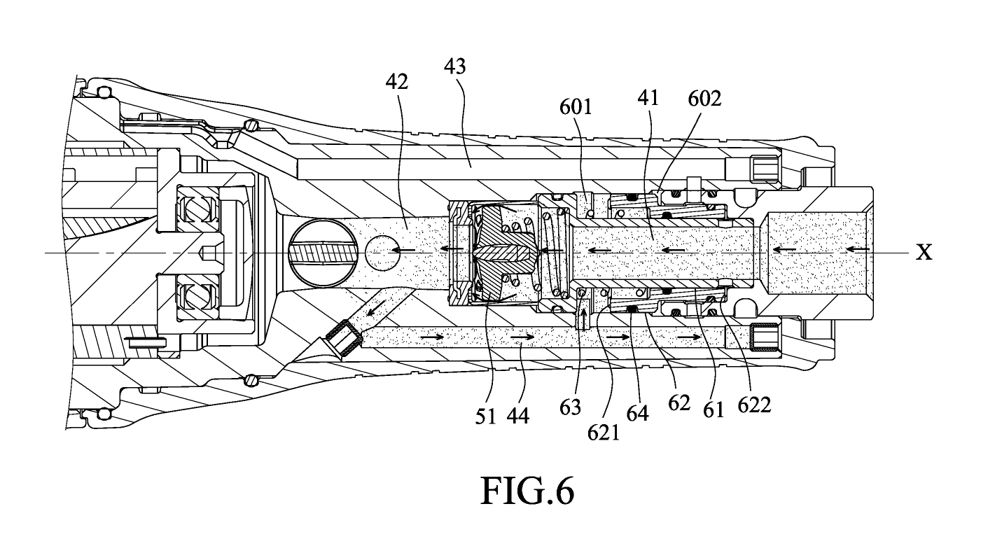

The valve unit 6 extends in the body 2 in the X-axis direction, and is parallel to the feeding path 41. In this embodiment, the valve unit 6 is disposed around the feeding path 41. Alternatively, the valve unit 6 may be located at a side of the feeding path 41. The valve unit 6 includes a valve sleeve 61 extending in the body 2 along the X-axis direction and defining the feeding path 41 therein, a valve member 62 sleeved movably on the valve sleeve 61 and disposed in the body 2, a resilient member 63, and an air seal 64. The valve member 62 is movable between a first position shown in FIG. 4 whereat fluid communication between the feeding path 41 and the secondary path 43 is opened, and a second position shown in FIG. 5 whereat fluid communication between the feeding path 41 and the secondary path 43 is closed. In this embodiment, the valve member 62 has a first end surface 621 facing the primary path 42, and a second end surface 622 opposite to the first end surface 621 such that an air pressure in the feeding path 41 is applied to the second end surface 622. The resilient member 63 is sleeved on the valve sleeve 61, and applies a pushing force to the first end surface 621. The pushing force is smaller than the air pressure in the feeding path 41. The air seal 64 is sleeved on the valve member 62 so as to establish an air-tight seal between the valve member 62 and the body 2. When the valve member 62 is disposed at the second position, a space between the valve sleeve 61 and the body 2 is divided into a first space portion 601 (see FIG. 6) and a second space portion 602 (see FIG. 6), which are located respectively at two sides of the air seal 64. The first space portion 601 is in fluid communication with the connecting path 44. The second space portion 602 is in fluid communication with the secondary path 43 and the discharging hole 45.

With particular reference to FIG. 3, when the body 2 is not connected with a compressed air source (not shown), there is not any airflow occurring the feeding path 41. In this state, the resilient member 63 pushes and moves the first end surface 621 of the valve member 62 so that the valve member 62 is disposed at the second position, thereby closing fluid communication with the feeding path 41 and the secondary path 43.

With particularly to FIGS. 4 and 5, when the body 2 is connected with the compressed air source, and the trigger 52 is not actuated, fluid communication between the feeding path 41 and the primary path 42 is closed by the switch valve 51, and flow of air from the feeding path 41 into the primary path 42 is prevented. In this state, since the pushing force of the resilient member 63 is smaller than the air pressure in the feeding path 41, the air pressure in the feeding path 41 pushes and moves the second end surface 622 of the valve member 62 so that the valve member 62 is moved to the first position, thereby allowing for flow of air from the feeding path 41 into the secondary path 43. Hence, a member (not shown) can be operated manually to switch the rotational direction of the driving head 31.

As such, since fluid communication between the feeding path 41 and the primary path 42 is closed by the switch valve 51, the driving head 31 cannot be rotated pneumatically.

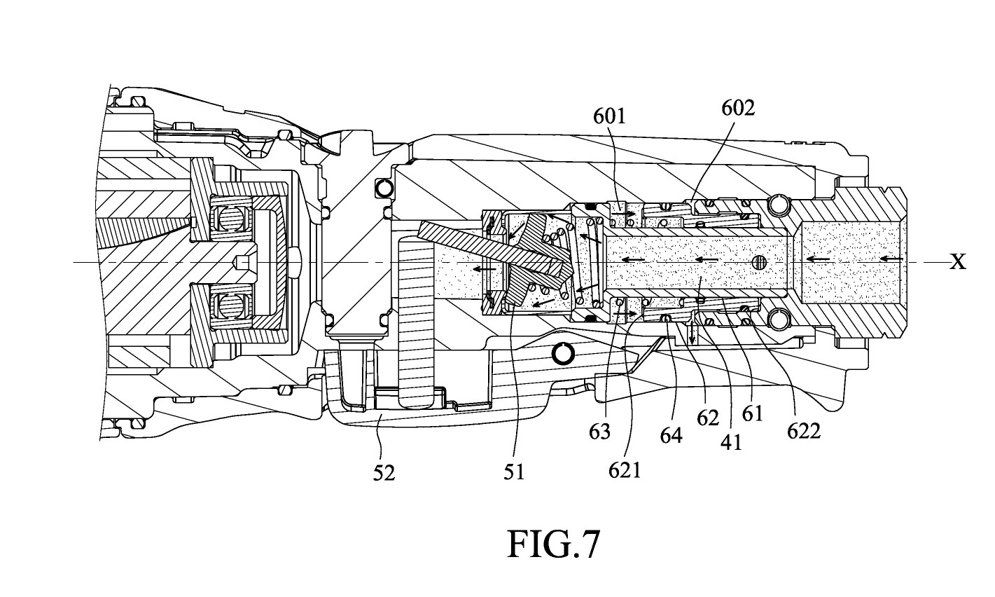

With particular reference to FIGS. 6 and 7, when the trigger 52 is actuated by one hand of a user gripping the body 2, the switch valve 51 is activated to open fluid communication between the feeding path 41 and the primary path 42 to thereby allow air to flow from the feeding path 41 into the primary path 42 and the connecting path 44. At this time, the driving head 31 is rotated as a result of flow of air into the primary path 42, and an air pressure in the connecting path 44 is applied to the first end surface 621 of the valve member 62, so that the air pressure in the connecting path 44 and the pushing force of the resilient member 63 are applied to the first end surface 621 simultaneously. Since sum of the air pressure in the connecting path 44 and the pushing force of the resilient member 63 is greater than the air pressure in the feeding path 41, the valve member 62 is moved to the second position, and the first space portion 601 is filled with air. In the second position, since fluid communication between the feeding path 41 and the secondary path 43 is closed, air cannot enter the secondary path 43, and thus the rotational direction of the driving head 31 cannot be switched.

It should be noted that, in this state, air in the second space portion 602 and the secondary path 43 is discharged through the discharging hole 45, thereby achieving pressure relief and preventing mis-switching so as to facilitate smooth movement of the valve member 62.

In view of the above, the pneumatic ratchet wrench of this invention has the following advantages:

1. To prevent the rotational direction of the driving head 31 from being switched during rotation of the driving head 31, it is only necessary to control the flowing direction of airflow, thereby resulting in a simple operation, a smooth operation of the components, and an increase in the service life.

2. The secondary path 43 and the connecting path 44 are parallel to and flank the feeding path 41 and the primary path 42. The valve unit 6 is disposed between the feeding path 41 and the secondary path 43, and extends along the X-axis direction. The valve member 62 is sleeved on the valve sleeve 61. Consequently, the pneumatic ratchet wrench is easy to assemble, and can be made at a low cost.

Furthermore, the total volume and the total length can be reduced effectively.

With this invention thus explained, it is apparent that numerous modifications and variations can be made without departing from the scope and spirit of this invention. It is therefore intended that this invention be limited only as indicated by the appended claims.

We claim:

1. A pneumatic ratchet wrench comprising:
a body;
a driving head extending into said body and rotatable about a Z-axis;
a flow path unit formed in said body and including a feeding path adapted to be in fluid communication with an air source and permitting flow of air thereinto, a primary path in fluid communication with said feeding path so as to guide flow of air to drive rotation of said driving head, a secondary path in fluid communication with said feeding path so as to guide flow of air to switch a rotational direction of said driving head, and a connecting path in fluid communication with said primary path;
a driving unit including a switch valve and a trigger, said switch valve being positioned so as to close fluid communication between said feeding path and said primary path, while allowing for flow of air from said feeding path into said secondary path, said trigger being disposed pivotally on said body; and
a valve unit extending in said body in an X-axis direction perpendicular to said Z-axis and parallel to said feeding path, said valve unit being in fluid communication with said feeding path and said connecting path and including a valve member that is retained at a first position by an air pressure in said feeding path so as to allow for flow of air from said feeding path into said secondary path;
wherein, upon actuation of said trigger, fluid communication between said feeding path and said primary path is opened to drive rotation of said driving head, and said valve member is moved to a second position so as to close fluid communication between said feeding path and said secondary path, thereby preventing switching of said rotational direction of said driving head.

2. The pneumatic ratchet wrench as claimed in claim 1, wherein said feeding path is connected fluidly to said primary path along said X-axis direction.

3. The pneumatic ratchet wrench as claimed in claim 2, wherein said secondary path and said connecting path extend along said X-axis direction, and flank an assembly of said feeding path and said primary path.

4. The pneumatic ratchet wrench as claimed in claim 1, wherein said valve unit further includes a valve sleeve extending along said X-axis and defining said feeding path therein, said valve member being sleeved movably on said valve sleeve and being disposed in said body.

5. The pneumatic ratchet wrench as claimed in claim 4, wherein said valve unit further includes a resilient member, and said valve member has a first end surface facing said primary path, and a second end surface opposite to said first end surface such that said air pressure in said feeding path is applied to said second end surface, said resilient member being sleeved on said valve sleeve and applying a pushing force to said first end surface, said pushing force being smaller than said air pressure in said feeding path, so that said valve member is moved to said first position when said trigger is not actuated, sum of said pushing force of said resilient member and an air pressure in said connecting path, which are applied to said first end surface, being greater than said air pressure in said feeding path when said trigger is actuated, so that said valve member is moved to said second position.

6. The pneumatic ratchet wrench as claimed in claim 1, wherein said flow path unit further includes a discharging hole adapted to be in fluid communication with the surroundings, and said valve unit further includes at least one air seal sleeved on said valve member so as to establish an air-tight seal between said valve member and said body such that, when said valve member is disposed at said second position, a space between said valve sleeve and said body is divided into a first space portion and a second space portion that are located respectively at two sides of said air seal, said first space portion being in fluid communication with said connecting path, said second space portion portion being in fluid communication with said secondary path and said discharging hole.
